(19) United States
(12) Patent Application Publication
(10) Pub. No.: US 2006/0035679 A1
(43) Pub. Date: Feb. 16, 2006

(54) Method for displaying pictures stored in mobile communication terminal

(75) Inventors: Yong-Hee Han, Buk-gu (KR); Ki-Tae Kim, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/193,392

(22) Filed: Aug. 1, 2005

(30) Foreign Application Priority Data
Aug. 10, 2004 (KR) 2004-62927

(51) Int. Cl. H04B 1/38

(52) U.S. Cl. 455/566; 455/418

(57) ABSTRACT

A method is provided for displaying pictures photographed by performing a camera function of a mobile communication terminal and stored in the mobile communication terminal. The method includes the steps of providing a three dimensional object including a plurality of substituting surfaces for substituting the stored pictures, bringing the three dimensional object to display the stored pictures, selecting a picture to be displayed among the stored pictures and substituting the picture for a substituting surface, according to an input of a predetermined movement key for front or rear movement of the stored pictures, and performing a preset animation display of the three dimensional object. The stored picture display operations of the mobile communication terminal are performed by using a three dimensional manner and through a proper animation, and the movement between the stored pictures is easier.

### PRIORITY

This application claims the benefit under 35 U.S.C. §119(a) of Korean Patent Application entitled “METHOD FOR DISPLAYING PICURES STORED IN MOBILE COMMUNICATION TERMINAL” filed in the Korean Industrial Property Office on Aug. 10, 2004 and assigned Serial No. 2004-62927, the entire contents of which are hereby incorporated by reference.

### BACKGROUND OF THE INVENTION

1. Field of the Invention

The present invention relates to an operation of a mobile communication terminal employing a camera module. More particularly, the present invention relates to a method for displaying photographed pictures by performing a camera function of a mobile communication terminal and stored in the mobile communication terminal.

2. Description of the Related Art

Recently, due to the rapid progress in telecommunications, development of mobile communication terminals having various functions has been required in addition to mobile communication terminals which transfer only voices. Therefore, recent mobile communication terminals have functions by which image and data communications are performed in addition to a function of voice communication. Especially, the mobile communication terminals employing digital camera modules, as well as camera phones having digital camera functions, are widely supplied and used.

A mobile communication terminal which employs a digital camera module comprises a function by which a scene or a moving image or the like is photographed and stored. Further, the mobile communication terminal comprises an image data transmitting and receiving function, and can transmit the image data of a photographed picture to another terminal by wireless communication through a base station and store the image data received from the base station. Further, the mobile communication terminal can be connected to a personal computer and can output the image data to the personal computer for display or storage.

Initially, the digital camera function employed in the mobile communication terminal employed only a function of photographing, storing, and transmitting image data. Technology developments for efficiency, quality and function improvement, however, have been performed to satisfy various desires of users. Recently, the digital camera function of the mobile communication terminal is equal to a general digital camera, or even superior to the digital camera in efficiency, quality, and functions. For example, the picture storing capacity of the terminal has increased, so that several tens to several hundreds of pictures can be stored in the terminal recently.

Generally, when managing the pictures stored in the mobile communication terminal, the terminal displays the stored pictures on a liquid crystal display section sequentially one by one. Namely, according to an input of direction keys (also, navigation keys), a stored picture before or after the displayed picture is taken and displayed sequentially on the display section. Then, the pictures are displayed in a slide manner.

According to the picture display manner, when a user wants to view a predetermined picture, the user should perform repetitively the input manipulations of the direction key by a number of times corresponding to the difference between the number of the currently displayed picture and the number of the picture to be viewed. Then, the stored pictures between the displayed picture currently and the picture to be viewed are displayed by the repetitive inputs of the direction key in a slide manner. However, the above-mentioned manner has a problem in that the repetitive inputs of the direction keys and the sequential display of pictures are bothersome and monotonous to the user. Especially, when the number of pictures is large, the problem of the picture display manner worsens.

### SUMMARY OF THE INVENTION

Accordingly, the present invention has been made to solve the above-mentioned problems occurring in the prior art, and an object of the present invention is to provide a method for displaying stored pictures in a mobile communication terminal to view the stored pictures more easily.

It is another object of the present invention is to provide a method for displaying stored pictures in a mobile communication terminal with improved visual effects.

In order to accomplish the above objects of the present invention, a method for displaying stored pictures in a mobile communication terminal comprises the steps of providing in advance a three dimensional object comprising a plurality of substituting surfaces for substituting the stored pictures, controlling the three dimensional object to display the stored pictures, selecting a picture to be displayed among the stored pictures and substituting the picture for a substituting surface, according to an input of a predetermined movement key for front or rear movement of the stored pictures, and performing a predetermined animation display of the three dimensional object.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a mobile communication terminal according to an embodiment of the present invention;

FIG. 2 is a flow chart illustrating camera mode operations for displaying stored pictures in a mobile communication terminal according to an exemplary embodiment of the present invention;

FIG. 3 is a flow chart illustrating operations for displaying stored pictures in a mobile communication terminal according to an exemplary embodiment of the present invention;

FIGS. 4a and 4b are schematic views illustrating a three dimensional object used to display stored pictures in a mobile communication terminal according to an exemplary embodiment of the present invention; and

FIGS. 5a to 5c are diagrams illustrating display screens of stored pictures in a mobile communication terminal according to an exemplary embodiment of the present invention.

Throughout the drawings, like reference numerals will be understood to refer to like parts, components and structures.

### DETAILED DESCRIPTION OF EXEMPLARY EMBODIMENTS

Hereinafter, exemplary embodiments of the present invention will be described with reference to the accompanying drawings. Although details are described in the following explanation, they are exemplary. Therefore, it will be understood by those skilled in the art that various changes in form and details may be made therein without departing from the spirit and scope of the invention.

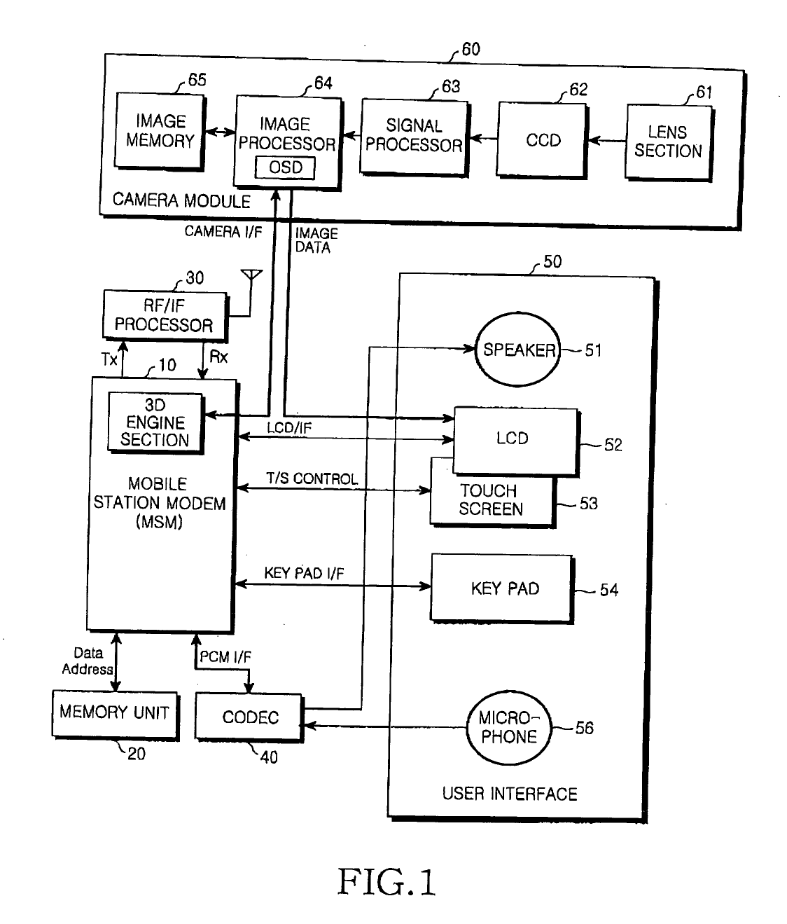

FIG. 1 is a block diagram illustrating a mobile communication terminal according to an exemplary embodiment of the present invention. The constitution and operation of an exemplary mobile communication terminal to which the present invention is applied is as follows with reference to FIG. 1. The mobile communication terminal comprises a user interface 50 for performing interface operations with a user and comprising a speaker 51, a display section 52, for example, a Liquid Crystal Display (LCD), a key pad 54, a microphone 56, a camera module 60 for performing camera functions and comprising a lens section 61, a pickup device 62, for example, a Charge Coupled Device (CCD), a signal processor 63, an image processor 64, an image memory 65, a radio frequency/intermediate frequency(RF/IF) processor 30 for performing radio signal processing operations, a memory 20 comprising a read only memory (ROM) and a random access memory (RAM) for storing various operation programs and operation-related data of the mobile communication terminal, an audio signal processor (coder/decoder (CODEC)) 40 for performing audio signal processing operation, and a mobile station modem (MSM) for performing functions controlling the entire mobile communication terminal and functions of a modem. Data about a three dimensional object used to display stored pictures can be stored in advance in the memory 20 according to an exemplary embodiment of the present invention.

Hereinafter, the constitutions and operations of the functioning parts are explained in greater detail. First, in the user interface, the microphone 56 converts the voice of a user to electrical signals, and the speaker 51 receives audio signals from the audio signal processor 40 and generates audible sounds during the conversation by phone. The key pad 54 comprises a plurality of number/letter keys for inputting a number or a letter and a plurality of function keys for selecting various functions for mobile communication and photographing and provides the corresponding key input data to the mobile station modem if there is a key input. The display section 52 generally having an LCD comprises an LCD controller (not shown), a memory for storing image data (not shown), and an LCD display device (not shown). The display section 52 displays letters of the information on the current state of the mobile communication terminal, a user menu, a background image, and a photographed image provided from the camera module 60, by the control of the mobile station modem 10. Then, a touch screen 53 can be employed in the LCD of the display section 52.

The RF/IF processor 30 comprises an radio frequency (RF) transmitter (not shown) for raising and amplifying the frequencies of transmitting signals, an RF receiver (not shown) for amplifying received signals so as to have low noises and lowering the frequencies of the signals. The RF/IF processor 30 converts the modulated signals received from the mobile station modem, and converts the signals to RF signals and transmits the radio frequency signals to a base station through an antenna. Further, the RF/IF processor 30 receives radio frequency signals from the base station through the antenna, and converts them into middle frequencies and base bandwidths sequentially and provides them to the mobile station modem.

The audio signal processor 40 generally comprising an audio codec converts analog audio signals received from the microphone 56 to digital signals (Pulse Code Modulation (PCM)) and transmits them to the mobile station modem, and converts digital signals (PCM) transmitted from the mobile station modem to analog signals and sends them to the speaker. Although the audio signal processor 40 is shown in a block separately, it can be included in the mobile station modem in one chip.

The mobile station modem 10 performs various functions of the mobile communication terminal according to key data input by using the key pad, and displays the information on the current state according to function performances, user menu. though the display section 52. Especially, when processing audio signals for communication by phone, after the PCM audio signals provided from the audio signal processor 40 are converted through channel coding and interleaving, they are modulated and provided to the RF/IF processor 30. Further, after audio signals provided from the RF/IF processor 30 undergo demodulation, equalization, channel decoding, and deinterleaving to generate PCM audio signals, and the signals are sent to the audio signal processor 40. The mobile station modem 10 comprises a 3D engine section for processing the stored pictures in three dimensional animation and displaying them according to an exemplary embodiment of the present invention.

In the camera module 60, the lens section 61 receives light from a subject. The light input in the lens section 61 proceeds to the pickup device 62. Generally, the pickup device 62 comprises a CCD or a Complementary Metal Oxide Semiconductor (CMOS). The optical signals input through the lens section 61 are converted to electrical signals having luminosity and color values of red, green, and blue and are output. The signal processor 63 comprises a Digital Signal Processor (DSP), and the signals output in the pickup device 62 undergoes a Correlated Double Sampling/Auto Gain Control (CDS/AGC) and the signals are converted to digital signals. The image processor 64 performs the picture processes of gamma correction, hue correction and the like to the signals output in the signal processor 63, and generates image data and provides them to the display section 52. The image data can be in National Television System Committee (NTSC), Phase Alternation by Line (PAL) or any other suitable format. The image processor 64 processes the output signals of the signal processor 63 in a frame unit, and outputs the image data of frame unit in conformance with the characteristics of the display section 52 and the size of the LCD. Then, the image processor 63 comprises an image codec, and compresses the frame image data displayed on the display section 52 in a predetermined manner or restores the compressed frame image data to the original frame image data. Here, the image codec can be, for example, a joint picture experts group (JPEG) codec, a moving picture experts group 4 (MPEG-4) codec, a Wavelet codec and the like. Further, the image processor 54 comprises an On Screen Display (OSD) function, and synthesizes the OSD data with the output image data by the control of the mobile station modem 10 and outputs the data. The image memory 65 comprises a memory for temporarily storing data needed for the image processing operations of the image processor 64 and a built-in memory for storing a plurality of photographed image data. Further, OSD data for displaying the information related to the camera operations can be stored in the image memory 65.

The operations of the mobile communication terminal having a structure shown in FIG. 1 are as follows. If a user performs a dialing operation by using the key pad 54 and establishes a signal transmitting mode, after the mobile station modem 10 detects the dialing operation and processes the input dialing information, the RF/IF processor 30 converts the information to radio signals and outputs the signals. Thereafter, a voice communicating line is formed so that the response signals of a partner subscriber which are received through the RF/IF processor 30, and the communication function are performed. In a signal arrival mode, the mobile station modem 10 detects the signal arrival mode through the RF/IF processor 30, and generates ring signals through the audio signal processor 40. Thereafter, if there is a response of the user, the mobile station modem 10 detects it and establishes a voice communicating line through the audio signal processor 40 to perform the communication function. Although the voice communication is explained as an example in the signal sending and arriving modes, the data communication function communicating packet data and image data is performed in addition to voice communication.

If a camera mode operation key provided in the key pad 54 for performing the camera mode or the camera mode in the menu setting mode of the mobile communication terminal is selected, the mobile station modem 10 operates the camera module 60 and displays the image data photographed by the camera module 60 on the display section 52. Further, the mobile station modem 10 stores the image of the frame in the image photographed when a shutter key provided in the key pad 54 is input. In the operation of the camera mode, the mobile communication terminal displays the pictures stored according to an exemplary embodiment of the present invention in a three dimensional manner, which will be explained in greater detail with reference to the accompanying drawings hereinafter.

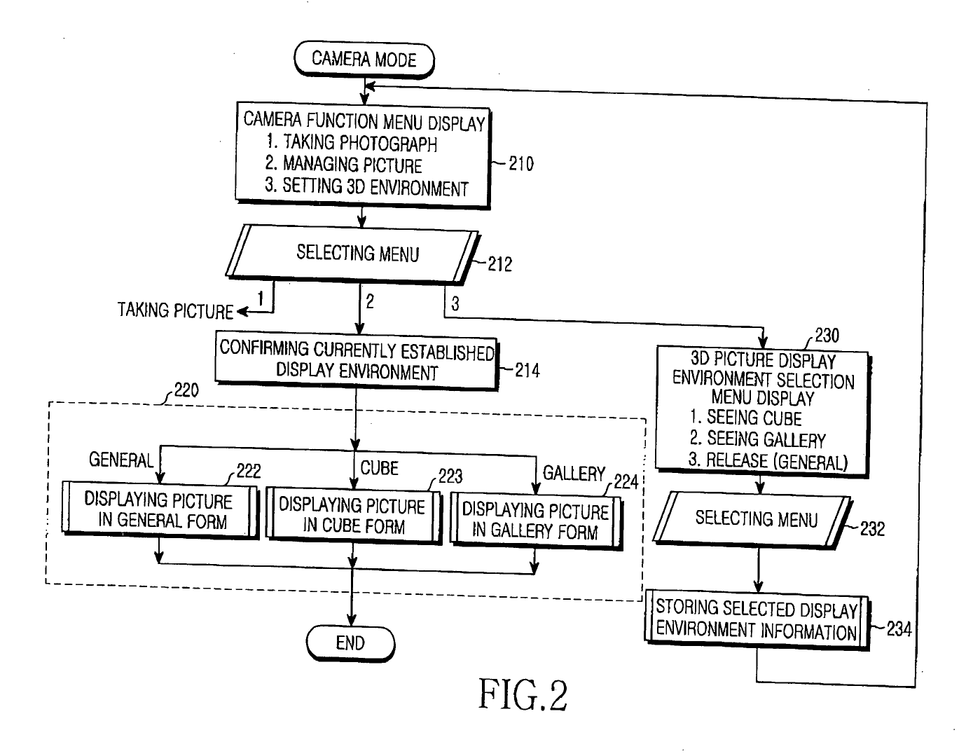

FIG. 2 is a flow chart illustrating camera mode operations for displaying pictures stored in a mobile communication terminal according to an exemplary embodiment of the present invention. If a camera mode operation key provided in the key pad 54 for performing the camera mode or the camera mode in the menu setting mode of the mobile communication terminal is selected, the mobile station modem 10 enters into the camera mode as shown in FIG. 2 and first displays a menu related to preset camera functions in step 210. Then, the camera function menu items comprise a menu item for displaying the pictures stored according to the characteristics of the present invention. For example, the camera function menu items can be No. 1 ‘Taking a picture’, No. 2 ‘Managing a picture’, and No. 3 ‘Setting 3D environment’. In step 210, a user can confirm the displayed camera function menu and can select a desired menu item by manipulating direction keys, confirmation keys and number keys. In step 212, the mobile station modem 10 performs an operation according to the selected menu after a menu selection is manipulated by the user.

In the case No. 3 ‘Setting 3D environment’ is selected in step 212, the mobile station modem 10 proceeds to step 230 and performs the operation of the 3D environment setting mode. In step 230, a preset 3D picture display environment selection menu is displayed according to the characteristics of the present invention. Then, the items of the 3D picture display environment menu are those for displaying the pictures stored according to the characteristics of the present invention in various kinds of three dimensional forms, and comprise items of No. 1 ‘Seeing a cube and No. 2 ‘Seeing a gallery’. In addition, the items can comprise a menu item for selecting the release of the 3D picture display environment. A user can confirm the 3D picture display environment selection menu displayed in step 230 and can select a desired menu item by manipulating the direction keys, the confirmation keys, and the number keys. In step 232, the user manipulates the menu selection through the mobile station modem 10, and then, in step 234, the selected 3D picture display environment information is stored and the step returns to step 210 to proceed the above-mentioned processes repetitively.

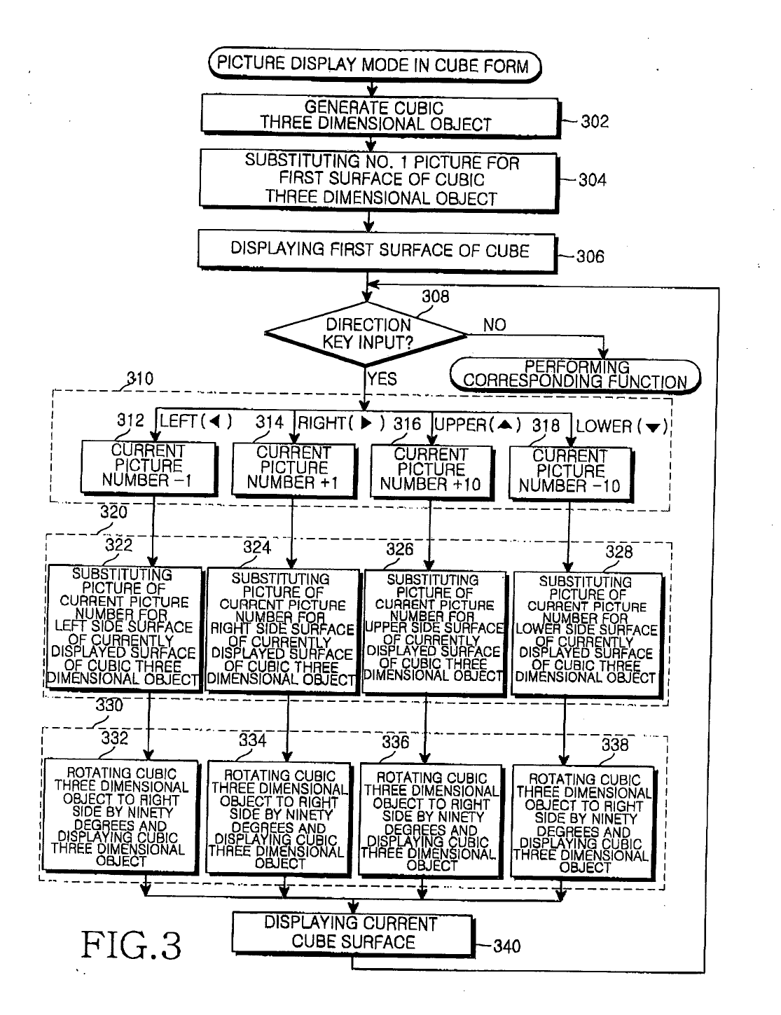

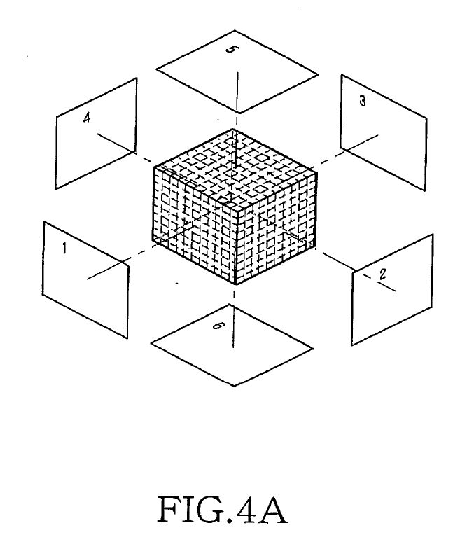

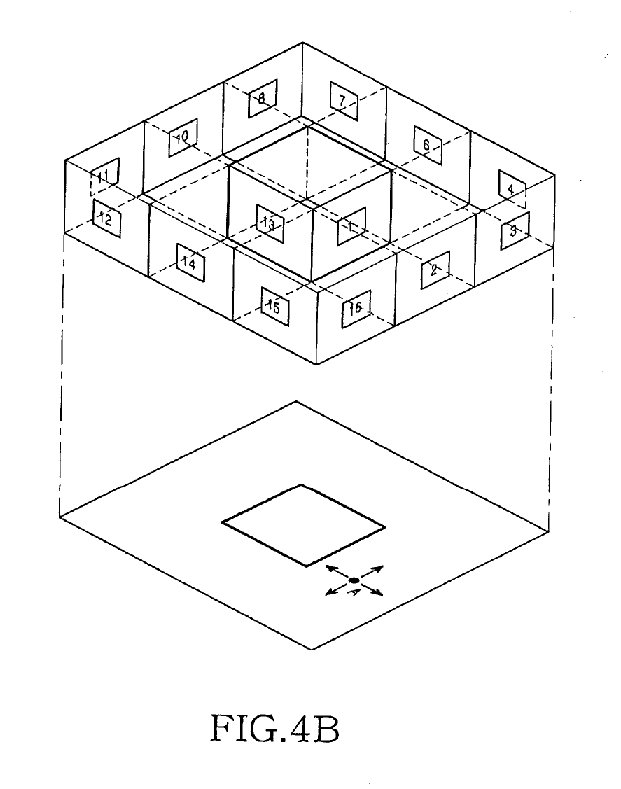

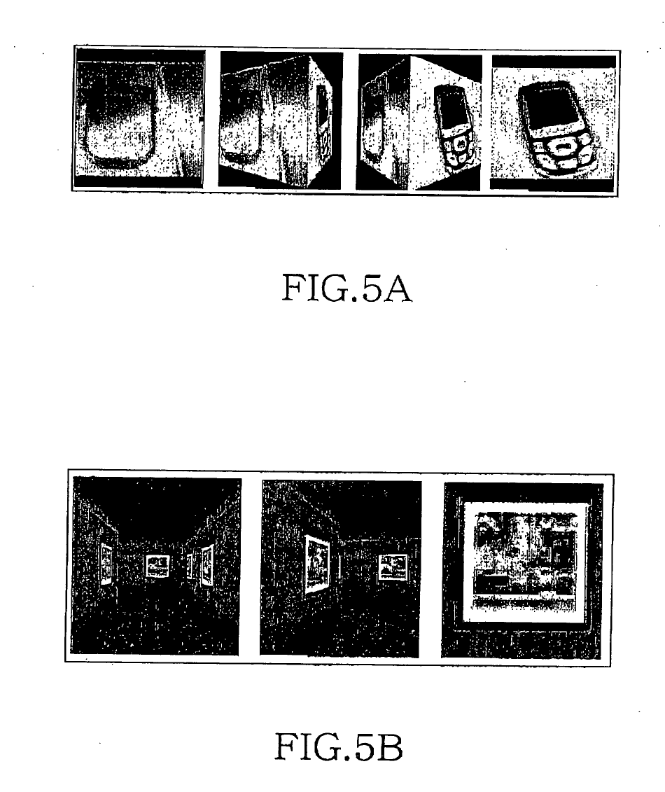

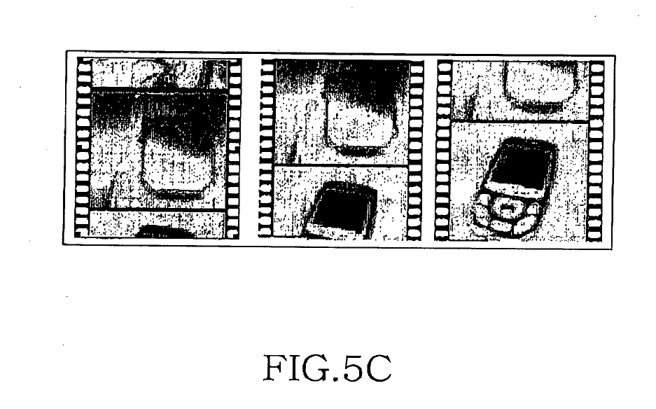

In contrast, in the case No. 2 ‘Managing a picture’ is selected in step 212, the mobile station modem 10 proceeds to step 214 to perform the operation of the following picture managing mode. In step 212, the currently established display environment is confirmed by confirming the display environment information stored in step 234 by the operation of the 3D environment setting mode. Then, in step 220, a mode for displaying the pictures stored in the display form according to the confirmed display environment. Namely, in step 220, the three lower steps of 222, 223, and 224 are selectively performed according to the currently stored display environment (No. 1 Seeing a cube, No. 2 Seeing a gallery, and No. 3 release). In step 222, the picture display mode is performed in a general form, which is a general slide form in which the 3D picture display is released, and in steps 223 and 224, the picture display mode is performed in a cube form and a gallery form respectively. Hereinafter, the processes in which the picture display mode is performed in the cube form and the gallery form of steps 223 and 224 will be explained in greater detail with reference to FIGS. 3 through 5. FIG. 3 is a flow chart illustrating operations for displaying pictures stored in a mobile communication terminal according to an exemplary embodiment of the present invention and shows processes performing a picture display mode in a cube form of step 223 shown in FIG. 2. FIGS. 4a and 4b are schematic views illustrating a three dimensional object used to display pictures stored in a mobile communication terminal according to an exemplary embodiment of the present invention, and FIGS. 5a to 5c are diagrams illustrating display screens of pictures stored in a mobile communication terminal according to an exemplary embodiment of the present invention.

As shown in FIG. 3, in step 302, the mobile station modem 10 generates a preset cubic three dimensional object as shown in FIG. 4a. Three dimensional objects of various shapes can be provided to display the stored pictures, the three dimensional objects of a cube shape and a gallery shape as shown in FIGS. 4a and 4b are provided as exemplary embodiments of the present invention. In the cubic three dimensional object shown in FIG. 4a, the stored pictures are substituted for surfaces of the cube. In the gallery three dimensional object formed of an outer hexahedron and an inner hexahedron provided in the outer hexahedron as shown in FIG. 4b, the pictures are substituted on the facing side surfaces of the inner and outer hexahedrons. The size of the three dimensional objects of the cube shape and the gallery shape are properly determined according to the size of the stored pictures.

After the cubic three dimensional object is generated in step 302, a first picture among the stored pictures is substituted for a first surface of the three dimensional object as shown in FIG. 4a, in step 304. Thereafter, the first surface of the cube for which the first picture is substituted is displayed in the display section 52 in step 306. Then, in the case the user wants to view stored pictures other than the currently displayed picture, movement keys, in other words, direction keys can be manipulated, and the mobile station modem 10 confirms in step 308 if a direction key, in other words, navigation key is input and the step proceeds to step 310 if the direction key is input.

In step 310, a number of a picture to be displayed next is confirmed according to an input of the left, right, upper, or right z,1 direction key. Namely, the four lower steps of 312, 314, 316, and 318 are selectively performed according to the input state of the currently input direction keys. In case of the left [symbol] input of the direction key, the number of the currently displayed picture is preferably decreased by one in step 312. In case of the right [symbol] input of the direction key, the number of the currently displayed picture is preferably increased by one in step 314. In case of the upper (▴) input of the direction key, the number of the currently displayed picture is preferably increased by, for example, ten in step 316. In case of the lower (▾) input of the direction key, the number of the currently displayed picture is preferably decreased by, for example, ten in step 318. When confirming the sequence of the picture number, the sequence wraps around to No. 1 after the last picture.

In step 320, the picture of the confirmed number in step 310 is substituted for a proper surface of the three dimensional object according to the input of the left, right, upper, or right [symbol] ▴, ▾) direction key. Namely, the four lower steps of 322, 324, 326, and 328 are selectively performed according to the input of the direction key in step 320. First, in case of the left [symbol] input of the direction key, step 322 is performed so that the picture of the confirmed number in step 312 is substituted for the left side surface of the currently displayed surface of the cubic three dimensional object. In case of the right [symbol] input of the direction key, step 324 is performed so that the picture of the confirmed number in step 314 is substituted for the right side surface of the currently displayed surface of the cubic three dimensional object. Similarly, in case of the upper and lower (▴, ▾) inputs of the direction keys, steps 326 and 328 are performed so that the pictures of the confirmed number in steps 316 and 318 are substituted for the upper and lower side surfaces of the currently displayed surface of the cubic three dimensional object.

For example, in the case the currently displayed surface of the three dimensional object is the first surface as shown in FIG. 4a, the previous picture of the currently displayed picture is substituted for the fourth surface of the cubic three dimensional object as the operations of steps 312 and 322 are performed. Further, as the operations of steps 314 and 322 are performed, the next picture of the currently displayed picture is substituted for the second surface of the cubic three dimensional object. Similarly, as the operations of steps 316 and 326 are performed, the picture of the increased number by ten is substituted for the fifth surface of the cubic three dimensional object, and as the operations of steps 318 and 328 are performed, the picture of the increased number by ten is substituted for the tenth surface of the cubic three dimensional object

Thereafter, in step 330, the cubic three dimensional object is rotated so that the surfaces for which the pictures are substituted in step 320 are displayed according to the left, right, upper, and lower inputs of the direction key. Namely, in step 330, the four lower steps of 332, 334, 336, and 338 are selectively performed according to the surfaces for which the pictures are substituted in step 310. First, in step 332, since the picture to be displayed next is substituted for the 25 left side surface of the currently displayed surface of the cubic three dimensional object in step 322, an animation display in which the cubic three dimensional object is rotated to the right by ninety degrees is performed to display the left side surface of the cubic three dimensional object. In step 334, since the picture to be displayed next is substituted for the right side surface of the currently displayed surface of the cubic three dimensional object in step 324, an animation display in which the cubic three dimensional object is rotated to the left by ninety degrees is performed to display the right side surface of the cubic three dimensional object. In the example of FIG. 5a, pictures selected properly among the animations by which the cubic three dimensional object is rotated to the left by ninety degrees and the right side surface of the cubic three dimensional object is displayed in step 336 are sequentially shown. Similarly, in steps 336 and 338, the animation display in which the cubic three dimensional object is rotated to the lower and upper sides is performed. After the operation of step 330, the rotated surface of the cubic three dimensional object is displayed in step 340 and the step returns to step 308 to proceed the above-mentioned processes repetitively.

By the operations as shown in FIG. 3, the stored pictures are shown as if the stored pictures constitute the surfaces and are displayed. Then, in case of the left and right [symbol] inputs of the direction keys, the pictures are shown as if the cube is rotated to the left and right sides and the stored pictures are displayed sequentially as surface of the 30 object. Further, in the case of the upper and lower (▴, ▾) inputs of the direction keys, the pictures are shown as if the cube is rotated to the upper and lower sides and the stored pictures are displayed sequentially, the number of the displayed picture jumping by a predetermined interval, for example, by ten.

The picture display mode is performed in a cube form through the processes as shown in FIG. 3, and the number of the currently displayed picture and the related information can be displayed at a predetermined position of the screen by using OSD. For example, if the number of the currently displayed picture is 1 and the number of the entire stored pictures, in other words, finally stored picture number is sixty, ‘[01/60]’ can be displayed on the screen.

In contrast, the picture display mode performed in a gallery form in step 224 of FIG. 2 will be explained. When the picture display mode is performed in the gallery form, a predetermined gallery three dimensional object as shown in FIG. 4b is generated. According to the inputs of the direction keys, the pictures are sequentially substituted for the positions, which are displayed by 1 to 16, of the opposite side surfaces of the two inner and outer hexahedrons. Further, by changing the display positions of the gallery three dimensional object, the user can obtain an effect by which the user can view the pictures, moving to the front, rear, left, and right sides in the gallery.

In the case the pictures are displayed in the gallery form, for example, the gallery three dimensional object can be displayed on the basis of a perspective view from position A of the bottom surface of the gallery three dimensional object as shown in FIG. 4b. Then, as shown in the display picture of FIG. 5b, No. 1 picture can be positioned on the front left side surface, and No. 2 and No. 3 pictures can be positioned on the front right side surface, and No. 4 picture can be positioned on the front surface. In the example of FIG. 5b, predetermined pictures properly selected among the animations rotating by ninety degrees are sequentially shown so that the No. 1 picture is displayed on the front surface on the basis of position A when there is a left [symbol] input of the direction key. In this way, by changing the basis position of the display of the gallery three dimensional object through the inputs of the direction keys, the user obtains an effect in which the user moves in a virtual gallery and views the pictures on the walls of the gallery.

As described above, the stored picture display operations of the mobile communication terminal according to an exemplary embodiment of the present invention can be performed. On the other hand, although detailed embodiments are explained in the specification, various changes in form and details may be made therein without departing from the spirit and scope of the invention. For example, although a cube and a gallery are explained as the three dimensional objects for which the stored pictures are substituted, animations of leaves of a book and an album can be used as the three dimensional objects. Further, as shown in FIG. 5c, a film shape in which the stored pictures are connected in series can be used as a three dimensional object. In the example of FIG. 5c, predetermined pictures properly selected among the animations in which the picture next to the currently displayed picture and displayed in a film shape by the lower (▾) input is scrolled to the upper side and displayed can be shown sequentially. In the example of FIG. 5c, the picture stored in the tenth next or following the currently displayed picture can be scrolled to the left or right side and displayed by the left or right [symbol] input of the direction key. As stated above, various changes in form and details may be made to the present invention, and therefore, the scope of the present invention is not limited to the described embodiments, but should be determined from the claims and their equivalents.

As mentioned above, according to exemplary embodiments of the present invention, the stored picture display operations of the mobile communication terminal are performed by using a three dimensional manner and through a proper animation, and the movement between the stored pictures is easier, and the visual effect is excellent, and a user can view the stored pictures more easily.

What is claimed is:

1. A method for displaying stored pictures in a mobile communication terminal, the method comprising the steps of:
generating a three dimensional object comprising a plurality of substituting surfaces for substituting the stored pictures;
selecting a picture to be displayed among the stored pictures and substituting the picture for a substituting surface, according to an input of a predetermined movement key for front or rear movement of the stored pictures;
displaying the three dimensional object with the selected picture displayed on the substituting surface; and
performing a predetermined animation display of the three dimensional object.

2. A method according to claim 1, wherein the three dimensional object is a cube shape, the substituting surfaces are surfaces of the cube shape, and the animation is the rotation of the three dimensional object of the cube shape.

3. A method according to claim 1, wherein the three dimensional object is a gallery shape, and the substituting surfaces are predetermined plural portions of the left and right side surfaces of the gallery shape.

4. A method according to claim 1, wherein the three dimensional object is a film shape in which the substituting surfaces are provided so that the stored pictures are connected in series.

5. A method for displaying stored pictures in a mobile communication terminal, the method comprising the steps of:
generating a three dimensional object of a cube shape for substituting the stored pictures for surfaces of the cube shape;
displaying the pictures by substituting a first picture for a first surface of the cubic three dimensional object;
confirming the number of the picture to be displayed next to the currently displayed picture;
substituting a picture of the confirmed number for a selected surface among the left, right, upper, and lower surfaces of the surface displayed currently in a predetermined manner;
performing a rotation animation of the cubic three dimensional object to display the surface for which the picture is substituted.

6. A method according to claim 5, wherein the confirmation of the number of the picture to be displayed next to the current displayed picture is performed by increment by one, decrement by one, increment by ten, or decrement by ten from the number of the currently displayed picture when the right, left, upper, or lower direction key is input.

7. A method according to claim 5, wherein the substitution of the picture of the confirmed number for the selected surface of the cubic three dimensional object is performed by substituting the picture for the left, right, upper, or lower surface of the currently displayed surface when the left, right, upper, or lower direction key is input.

8. A method for displaying stored pictures in a mobile communication terminal, the method comprising the steps of:
providing a plurality of three dimensional objects, each comprising a plurality of substituting surfaces for substituting the stored pictures;
selecting a three dimensional object among the plurality of three dimensional objects;
generating the selected three dimensional object to display the stored pictures;
selecting a picture to be displayed among the stored pictures and substituting the selected picture for a substituting surface of the selected three dimensional object according to an input of a direction key set for the front or rear movement of the stored pictures; and
performing a predetermined animation display of the three dimensional object.

9. A method according to claim 1, wherein the plurality of three dimensional objects comprises a cube shape and a gallery shape.
